(19) United States
(12) Patent Application Publication
(10) Pub. No.: US 2024/0114034 A1
(43) Pub. Date: Apr. 4, 2024

(54) Generation of the Digital Fingerprints Library with Hierarchical Structure

(71) Applicant: Acronis International GmbH, Schaffhausen (CH)

(72) Inventors: Nickolay Berko, Schaffhausen (CH); Serg Bell, Singapore (SG); Stanislav Protasov, Singapore (SG)

(21) Appl. No.: 17/936,414

(22) Filed: Sep. 29, 2022

(51) Int. Cl. H04L 9/40

(52) U.S. Cl. CPC H04L 63/105; H04L 63/0876

(57) ABSTRACT

A system and method for adding a fingerprint of a fragment of fixed size and hierarchical classification level to a digital fingerprint library containing information about fingerprints of fragments of fixed size and their hierarchical classification levels and used to identify files that contain known fragments of data in an environment with hierarchical information security classification.

### FIELD OF THE INVENTION

The present disclosure generally relates to data security. In particular, the present disclosure relates to a system and method for assigning a security classification level to creation of a library of fingerprints of fragments of a fixed size that contain information from sources that have different security classification where such classification is hierarchical, e.g., Level 0, Level 1, Level 2 or Public, Secret, Top Secret, etc.

### BACKGROUND OF THE INVENTION

With the advent of digital technology and the ever-increasing value of digital assets and related constantly evolving cyber security threats, data security has become a critical issue in all aspects of computer technology. Organizations and private citizens store valuable information in their digital information systems. While a company may have internal controls to safeguard its digital assets within the corporate perimeter, once such information leaves that perimeter, it may be harder to control it.

To better manage digital assets and prevent unauthorized release of these assets, companies deploy automatic systems that detect events when certain information is about to cross corporate virtual security perimeter. One of the methods to do so is fingerprinting of known documents that contain protected data. For example, fingerprints may be created in the form of hashes of known documents that contain protected data. When an unknown file is about to cross the virtual security perimeter the fingerprint of that file is compared to the fingerprints of all known files that contain protected information. If the fingerprint of the unknown file matches one of the fingerprints of the files known to contain protected information, it is marked.

A similar problem arises when there is a need to identify files containing partial fragments that have been copied from files known to contain protected information. In that case, fingerprinting of the entire file will not be able to detect the presence of a fragment of one file within another file when even at least one symbol in these files is different.

A method and system are needed that can allow for identification of fragments of different hierarchical classification levels in unknown documents.

### SUMMARY OF THE INVENTION

The present invention operates in an environment where each file has an explicit or implicit (normally—the lowest level) classification Level(i) where when i>j, the level of classification Level(i) is a higher level of classification than Level(j). These levels may have their names or be numbered. For clarity, these will be addressed as Level(0), Level(1), . . . , Level(k).

The present invention operates with the term “fingerprint.” A fingerprint is a value generated based on the contents of a file such as when two fingerprints are different, with large (or overwhelming) probability the files are also different. An example of a fingerprint is a hash function including a cryptographic hash function. Usually, digital fingerprints have the same size. For a fragment of fixed length N, the fragment itself is its own fingerprint.

The present disclosure discloses the method and system of creation of a digital fingerprint library DFL of fingerprints of fragments of fixed size N, N-fragments, of files containing protected information in an environment with hierarchical data classification. The DFL is created in such a way to reflect rules of management of protected information with hierarchical information.

The use of cryptographic hash functions as fingerprints in this invention allows to create a DFL in such a way that information from the library cannot be reversed, and fragments of different security levels cannot be reconstructed even if the library is disclosed to an attacker.

In an embodiment, N-fragments of known files containing protected data are generated using the sliding window process.

### DESCRIPTION OF THE DRAWINGS

FIG. 1 depicts a block diagram of the generic method of adding a fingerprint of an N-fragment with hierarchical security level to DFL.

FIG. 2 depicts a block diagram of the method of adding fingerprints of N-fragments generated from a file with hierarchical security level to DFL, according to one of the embodiments.

FIG. 3 depicts a block diagram of the system that implements the method of adding the fingerprint of an N-fragment with hierarchical security level to DFL.

FIG. 4 depicts a block diagram of the system that implements the method of adding to DFL of fingerprints of N-fragments generated from a file with hierarchical security level.

### DETAILED DESCRIPTION

about

[symbol]

The present disclosure relates to creation and updating of a digital fingerprint library (“DFL”) that stores fingerprints of N-fragments of known documents containing protected information. The purpose of such a library is to compare fingerprints of N-fragments of an unknown document to fingerprints stored in DFL to detect protected data in an unknown file. Such inspection is needed, e.g., when an unknown file was prepared for sharing via, e.g., a communication system or copying to an external USB drive or other destination.

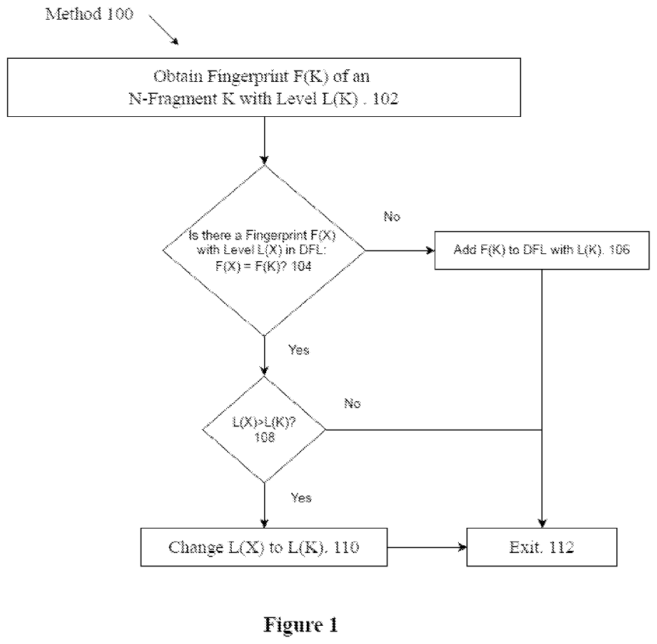

FIG. 1 depicts a block diagram of the process of adding fingerprint F(K) of an N-fragment K with hierarchical security level L(K) to DFL.

The first step 102 in the process is obtaining the fingerprint F(K) of an N-fragment K with security level L(K).

In an embodiment, step 102 is preceded by a step of calculating fingerprint F(K) from N-fragment K.

In an embodiment, the fingerprint F(K) of the N-fragment K is its hash value.

The next step 104 is identification of a fingerprint F(X) within DFL such that F(K)=F(X). If such a fragment does not exist, the fingerprint F(K) is added to DFL with its original security level L(K) at step 106, followed by exiting the process at step 112.

If there is a fingerprint F(X) within DFL such that F(K)=F(X), the process moves to step 108 where security levels L(K) and L(X) corresponding to fingerprints F(K) and F(X) are compared. If the security level L(X) is greater that L(K), then the signature F(X) of the N-fragment X that was previously recorded in DFL with a higher security level, was found with a lower access level L(K), and hence the security level of F(X) in DFL is lowered from L(X) to L(K) at 110.

If the security level L(X) is not greater than L(K), then the process terminates at 112.

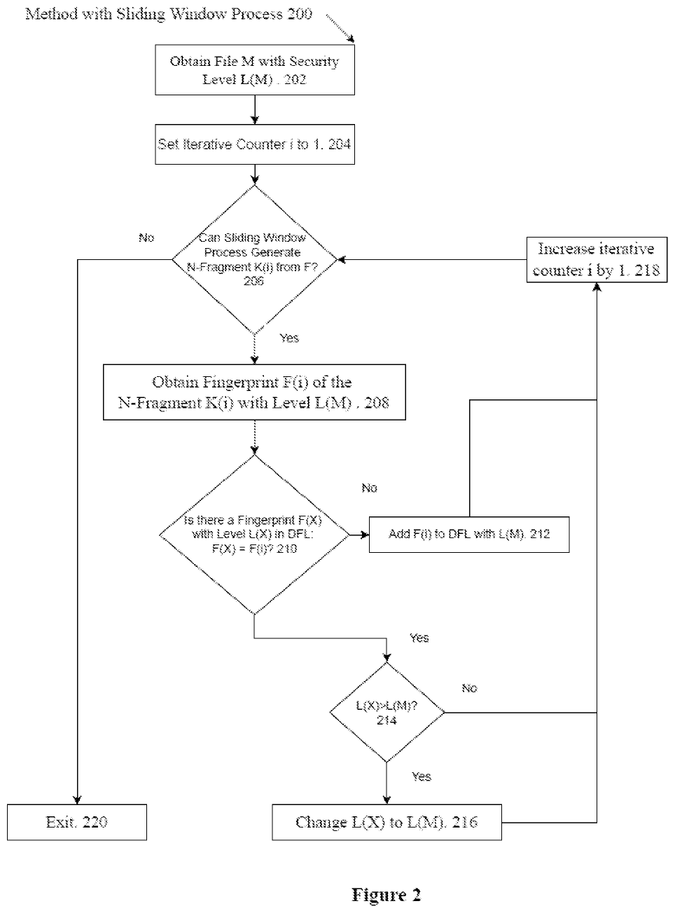

FIG. 2 depicts a block diagram of the process of adding fingerprints of N-fragments to DFL from a file M with hierarchical data level L(M).

The process starts with obtaining the file M with security level L(M) at step 202.

In an embodiment, if the file M does not have a security level assigned to it, the lowest security level S0 is assigned to it at step 202.

In an embodiment, if the file M does not have a security level assigned to it, the file is marked for further review and the process terminates.

The iterative process begins with setting the iteration counter i to 1 at step 204.

Step 206 checks if the sliding window process can generate one more N-fragment.

If there are no more N-fragments to process, the method exits at step 220.

If the sliding window can generate another N-fragment, then the process moves to step 208.

The next step 208 in the process is generating the N-fragment K(i) that inherits the security level L(M) from the file M, obtaining the fingerprint F(i) of the N-fragment K(i) with security level L(M), and passing the fingerprint F(i) and the security level L(M) to step 210.

The next step 210 is identification of a fingerprint F(X) within DFL such that F(i)=F(X). If such a fragment does not exist, the fingerprint F(i) is added to DFL with its original security level L(M) at step 212, followed by increasing the iteration counter by one at step 218 and transferring control to step 206.

If there is a fingerprint F(X) within DFL such that F(i)=F(X), the process moves to step 214 where security levels L(M) and L(X) corresponding to fingerprints F(i) and F(X) are compared. If the security level L(X) is greater that L(M), then the fingerprint F(X) of the N-fragment X that was previously recorded in DFL with a higher security level L(X) was found with a lower access level L(M), and hence the security level for F(X) within DFL is lowered from L(X) to L(M) at 216, followed by increasing the iteration counter by 1 in step 218 and transferring the control to 206.

If the security level L(X) is not greater than L(M) in 214, then the process moves to step 218 where the iteration counter is increased by one and the control is transferred to step 206.

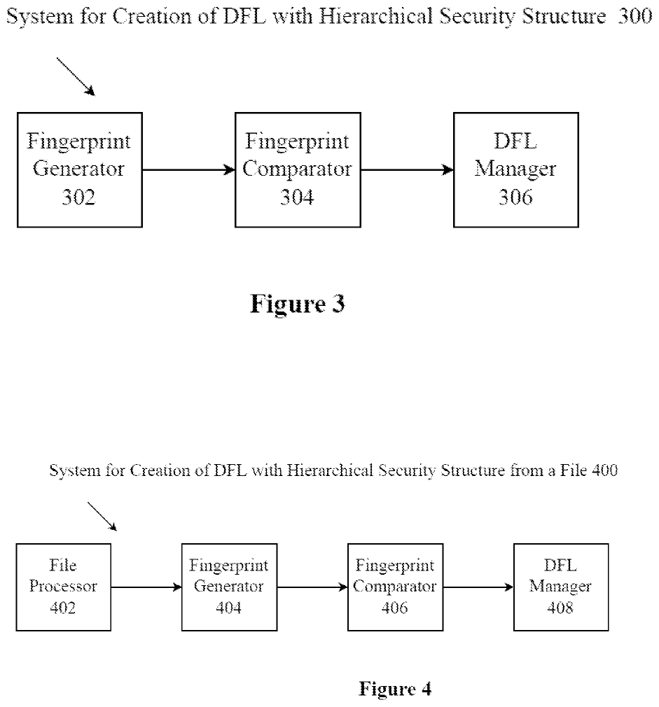

FIG. 3 depicts a block diagram of the system 300 implementing the process of adding a fingerprint F(K) of an N-fragment K with hierarchical security level L(K) to DFL.

The system 300 consists of the Fingerprint Generator 302, the Fingerprint Comparator 304, and the DFL Manager 306.

In an embodiment, the Fingerprint Generator 302 is optional, and the Fingerprint Comparator 304 receives the information about the fragment F(K) and its hierarchical security level L(K) from another source.

The Fingerprint Generator 302 is configured to obtain an N-fragment K with security level L(K) and generate a fingerprint F(K) from that N-fragment K and to transfer it to the Fingerprint Comparator 304.

The Fingerprint Comparator 304 is configured to: identify if a fingerprint F(X) within DFL exists such that F(X)=F(K) and, if such fingerprint exists, compare its security levels L(X) to L(K).

The Fingerprint Comparator 304 is further configured to communicate to the DFL Manager 306 if there is a need to add the fingerprint F(K) with security level L(K) do DFL, update security level of F(X) from L(X) to L(K) or perform neither.

The DFL Manager 306 is configured to receive a recommendation from the Fingerprint Comparator 304 of whether there is a need to add the fingerprint F(K) with security level L(K) to DFL, update security level of F(X) from L(X) to L(K) or perform neither.

In an embodiment, the DFL Manger 306 is further configured to perform the recommended task.

FIG. 4 depicts a block diagram of the system 400 implementing the process of adding fingerprints F(i) of N-fragments K(i) generated from a file M with hierarchical security level L(M) to DFL.

The system 400 consists of File Processor 402, Fingerprint Generator 404, the Fingerprint Comparator 406, and DFL Manager 408.

The File Processor 402 is configured to obtain a file M with a hierarchical security level L(M) and to generate N-fragments K(i), each fragment K(i) with the security level L(M) inherited from the file M.

In an embodiment, if the file M has no assigned security level, the File Processor 402 is configured to assign the lowest security level LO to the security level L(M).

The Fingerprint Generator 404 is configured to obtain from the File Processor 402 an N-fragment K(i) that inherits the security level L(M) from the file M and to generate a fingerprint F(i) from the N-fragment K(i) and to transfer it along with the security level L(M) to the Fingerprint Comparator 406.

The Fingerprint Comparator 406 is configured to: identify if a fingerprint F(X) exists within DFL such that F(X)=F(i) and, if such fingerprint exists, compare its hierarchical security levels L(X) to L(M).

The Fingerprint Comparator 406 is further configured to communicate to the DFL Manager 408 if there is a need to add the fingerprint F(i) with security level L(M) to DFL, update security level of F(X) to L(M) or perform neither.

The DFL Manager 408 is configured to receive a recommendation from the Fingerprint Comparator 406 of whether there is a need to add the fingerprint F(i) with security level L(M) to DFL, update security level of F(X) to L(M) or perform neither.

In an embodiment, the DFL Manger 408 is configured to perform the recommended task.

1. A method for adding a fingerprint F(K) of a fragment K of fixed size N, an N-fragment, with a hierarchical security classification level L(K) to a digital fingerprint library (“DFL”), containing fingerprints of K-fragments F(X) and their corresponding hierarchical security classification levels L(X), the method comprising the steps of:
a. obtaining a fingerprint F(K) of an N-fragment K with hierarchical classification level L(K);
b. checking if a fingerprint F(X) exists within DFL such that F(X)=F(K);
c. if a there are no fingerprints within DFL matching F(K), adding the fingerprint F(K) with hierarchical security level L(K) to DFL;
d. if a fingerprint F(X) exists within DFL such that F(X)=F(K), comparing their respective hierarchical security levels L(X) and L(K);
e. if a fingerprint F(X) exists within DFL and L(X)>L(K), changing the security level of F(X) in DSL from L(X) to L(K).

2. The method of claim 1, wherein the step of obtaining the fingerprint is preceded by the step of generating the fingerprint F(K) from an N-fragment K.

3. The method of claim 1 where the step of obtaining the fingerprint is preceded by the step of processing a file M with hierarchical security level L(M), generating N-fragments K(i) from it using the sliding window method and assigning these fragments security level L(M) of the file M; the step of obtaining the fingerprint obtains the fingerprint from the file processing step.

4. The method of claim 1 wherein the step of obtaining the fingerprint further comprises the step of connecting to a source of N-fragments K(i) with corresponding hierarchical security levels L(i) and generating corresponding fingerprints F(i) from N-fragments K(i).

5. The method of claim 1 wherein the step of obtaining the fingerprint further comprises the step of connecting to a source of fingerprints F(i) with corresponding hierarchical security levels L(i).

6. The method of claim 1, wherein the step of obtaining the fingerprint further comprises assigning the fingerprint F(K) the lowest level of hierarchical security level to that fingerprint if the security level has not been previously set up.

7. The method of claim 1, wherein there is a hash value of the N-fragment.

8. A system for adding a fingerprint F(K) of a fragment K of fixed size N, an N-fragment, with hierarchical security level L(K) to the digital fingerprint library DFL, containing fingerprints F(X) of N-fragments X and their corresponding hierarchical security classification levels L(X), the system comprising:
a. a fingerprint comparator configured to:
i. obtain a fingerprint F(K) of an N-fragment K with corresponding hierarchical security level L(K);
ii. identify if a fingerprint F(X) of an N-fragment X exists within DFL such that F(X)=F(K);
iii. if a fingerprint F(X) of an N-fragment X exists within DFL such that F(X)=F(K), to compare its hierarchical security classification levels L(X) to L(K);
iv. communicate to a DFL manager the recommendation whether to add F(K) with L(K) to the DFL, change the hierarchical security level of F(X) in DFL from L(X) to L(K), or to do neither.
b. a DFL manager configured to accept a recommendation from the fingerprint comparator a recommendation whether to add F(K) with L(K) to DFL, change the hierarchical security level of F(X) in DFL from L(X) to L(K), or to do neither.

9. The system of claim 8, wherein the fingerprint of an N-fragment is its hash value.

10. The system of claim 8, wherein the fingerprint classifier is also configured to generate the fingerprint from an N-fragment.

11. The system of claim 8, wherein the fingerprint comparator receives information about fingerprints from a file processor, obtains a file M, and generates N-fragments K(i) using a sliding window process.

12. The system of claim 8, wherein the fingerprint comparator receives information about fingerprints from a source of fingerprints of N-fragments and related hierarchical security levels from a database, a file storage, or a mobile device.
